(19) United States
(12) Patent Application Publication
(10) Pub. No.: US 2023/0137563 A1
(43) Pub. Date: May 4, 2023

(54) SYSTEMS AND METHODS FOR PRODUCT OWNERSHIP RECORDATION AND VALIDATION

(71) Applicant: CyberSoteria Limited Company, Coppell, TX (US)

(72) Inventors: Lixiang Chen, Coppell, TX (US); Courtney Jane Chen, Dallas, TX (US)

(21) Appl. No.: 17/452,700

(22) Filed: Oct. 28, 2021

(51) Int. Cl. G06Q 30/00; H04L 9/32; G06F 21/64

(52) U.S. Cl. CPC G06Q 30/018; H04L 9/3236; G06F 21/64; G06Q 2220/00

(57) ABSTRACT

Methods for product ownership recordation and validation and corresponding systems and computer-readable mediums. A method includes receiving product data and an owner identification (ID) corresponding to a product and generating a validation seed associated with the product data. The method includes generating a title ID using the validation seed and generating a digital title corresponding to the title ID. The digital title or title ID is stored by the data processing system as associated with the validation seed and the owner ID. The method includes returning the digital title.

### CROSS-REFERENCE

The present application contains some subject matter in common with, but is otherwise unrelated to, concurrently-filed U.S. patent application Ser. No. ______, titled “Systems and Methods for Product Validation” (docket number CYBE01-00002).

### TECHNICAL FIELD

The present disclosure is directed, in general, to systems and methods for validating genuine products. Various embodiments include systems and methods for generating identifiers for uniquely and securely marking products and systems and methods for validating the identifiers.

### BACKGROUND OF THE DISCLOSURE

Each year, the loss attributed to counterfeit products continues to increase. In 2017, the estimated global estimated loss caused by product counterfeiting was $1.2 trillion USD, and that estimation reached $1.82 trillion USD in 2020. Product counterfeiting is damaging to the legitimate manufacturers, the affected industry, and national and global economies.

One practice that is employed by manufacturers and retailers to track their goods and to prevent counterfeiting is to use one- or two-dimensional printed barcodes or Near-Field Communication (NFC) chips. However, the barcode or the contents of an NFC chip can be copied, replicated, or decoded by counterfeiters and therefore cannot function to confirm the authenticity or provenance of the product. As a result, counterfeits with the same product code are sold or exchanged without being detected. Improved systems are desirable.

### SUMMARY OF THE DISCLOSURE

Various disclosed embodiments include methods for product ownership recordation and validation and corresponding systems and computer-readable mediums. A method includes receiving product data and an owner identification (ID) corresponding to a product and generating a validation seed associated with the product data. The method includes generating a title ID using the validation seed and generating a digital title corresponding to the title ID. The digital title and/or title ID can be stored by the data processing system as associated with the validation seed, product data, and/or the owner ID. The method includes returning the digital title.

In various embodiments, generating the title ID includes using a hash function or cryptographic function on the validation seed, alone or on combination with the associated product data and/or the owner ID.

The method can also include receiving an unvalidated digital title for the product and validating the unvalidated digital title. Validating the unvalidated digital title can include receiving a title ID corresponding to the unvalidated digital title, identifying a stored digital title corresponding to the received title ID, determining whether the received title ID matches a title ID associated with the stored digital title, and returning a validation result according to the determination.

Various embodiment can include determining whether the stored digital title is a current digital title, where the returning the validation result is according to both the determination of whether the received title ID matches the title ID associated with the stored digital title and the determination of whether the stored digital title is the current digital title.

In various embodiments, the received title ID is valid only when both the received title ID matches the title ID associated with the stored digital title and the stored digital title is the current digital title.

Various embodiments can include sending a message to a validated current owner of the product to verify transfer to title of the product to a new owner, where the new owner corresponds to the received owner ID.

Various embodiments include a data processing system having a memory and at least one processor operatively connected to the memory and configured to perform processes as described herein. Various embodiments include a machine-readable medium encoded with executable code that, when executed, cause one or more processors to perform processes as described herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a system in which various embodiments can be implemented;

FIG. 2 illustrates a block diagram of a data processing system in which an embodiment can be implemented;

FIG. 3 illustrates a flowchart of a process in accordance with disclosed embodiments;

FIG. 4 illustrates a flowchart of a process in accordance with disclosed embodiments; and

FIG. 5 illustrates a flowchart of a process in accordance with disclosed embodiments.

### DETAILED DESCRIPTION

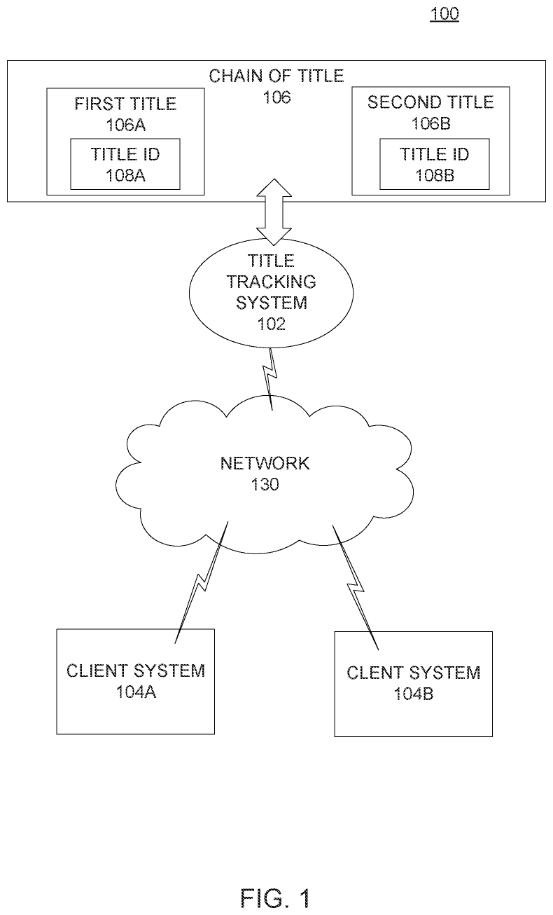

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include for validating ownership of a product, which can include generating and tracking one or more encrypted ownership digital certificates that validate and track ownership of the product. Such digital documents are referred to herein as a “digital title” to the product to distinguish from other common uses of the term “digital certificate.” The “products” can be physical, virtual, or digital (such as software and electronic media) products that are associated with the digital titles described herein.

In various embodiments, the digital title is implemented as a one-way encrypted ownership digital certificate, and a “cloud” service or server data processing system, generally referred to as the “title tracking system” herein, can be used to store and maintain all digital titles of a product. In the title tracking system, all of the digital titles for a product are associated with the product, so that the product's current ownership and chain of title can be tracked from the stored digital titles. Manufacturers, distributors, or retailers, for example, can use the product ownership history information to effectively identify, authenticate, and verify a product.

FIG. 1 illustrates an example of a system 100 in which various embodiments can be implemented, from a high-level perspective. In this example, title tracking system 102 represents one or more data processing systems (also referred to simply as computers) configured to perform processes as described herein, which can include processing received product and/or owner information, generating the digital titles, tracking the digital titles, validating digital titles, and other processes as described herein. Note that while validation system 102 is illustrated as a single “system,” title tracking system 102 can be implemented as one or more computers whether commonly located, distributed, implemented in physical or virtual machines, as a private server system or systems, as a cloud system or otherwise, and the operations of the title tracking system 102 may be under the control of the owner(s) of the physical computer(s) or of a party or parties that contract for processing on the physical computers. Moreover, specific operations described herein may be performed by different physical or virtual computers, whether concurrently or at different times, and so the title tracking system 102 as may be claimed herein should be understood to include only those computers performing processes required by a specific claim or claims at issue.

In this example, title tracking system 102 communicates over network 130 with one or more other computers as described herein. Network 130 represents any combination of public or private computer networks, including the Internet, whether wired or wireless, and will be generally understood to include any data communication path(s) between the validation system and the respective other computers.

In this example, one or more client systems 104A-104B (each a client system 104) each represents one or more data processing systems configured to send product information, owner information, or a digital title for a product to the title tracking system 102, or other data as described herein, and to receive similar information or digital titles as described. While this example illustrates two client systems 104, those of skill in the art will recognize that any number of client systems 104 can be employed to perform processes as described herein.

As illustrated in FIG. 1, title tracking system 102 maintains a chain of title 106 for each of one or more products as described herein. Chain of title 106 includes one or more associated digital titles 106A/106B as described herein that reflect the sequence of ownership of the associated product, and each digital title 106A/106B has an associated (or included) title ID 108A/108B. While this example shows just two digital titles 106A/106B in a chain of title 106 for a product, those of skill in the art will understand that any number of digital titles can be part of a chain of title 106 to record the ownership history of the associated product. Each digital title can include dates of acquisition or ownership of the product, or dates of recordal of the digital title, reflecting when each digital title became the effective for the associated product. The most-recent digital title in the chain of title 106 reflects the current recorded ownership of the associated product, and so references to the current digital title refer to the most-recent digital title in the chain of title 106. In some embodiments, the chain of title 106 may only store or be associated with the current digital title, and so references to the current digital title and references to the chain of title reflect the same ownership data. Note that chain of title 106 need not be implemented as a separate data structure or container, but can be implemented, for example, as a common identifier in each of the digital titles, so that the digital titles are associated with each other using the chain-of-title common identifier.

For example, a chain of title 106 could include four different digital titles associated with a product: a first digital title showing that the first owner of the product was the manufacturer of the product; a second digital title showing that the second owner of the product was a retailer; a third digital title showing that the third owner of the product was a first individual; and a fourth digital title showing that the fourth owner of the product was a second individual. Dates associated with each digital title could indicate dates corresponding to when the product was manufactured, when it was shipped to the retailer, when it was sold by the retailer to the first individual, and when it was sold or given by the first individual to the second individual. Of course, these dates may not be exact to each of these events, but may only reflect when the digital chain of title 106 was updated with new digital titles showing the change of ownership.

This is a non-limiting example, since the first (recorded) owner is not necessarily a manufacturer, but could be a retailer, customer, or otherwise. Once server software registers the initial ownership of a product, the subsequent ownership digital certificate transfers are performed by the title tracking system.

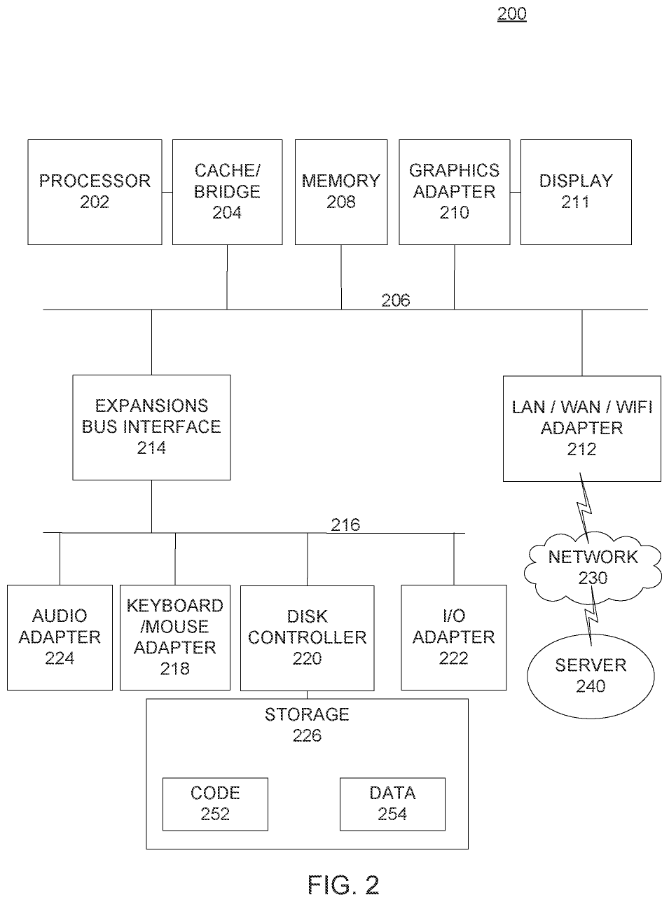

FIG. 2 illustrates a block diagram of a data processing system in which an embodiment can be implemented, for example as a computer system particularly configured by software or otherwise to perform the processes as described herein, and in particular as each or any one of a plurality of interconnected and communicating systems as described herein. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210. The graphics adapter 210 may be connected to display 211.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 216 is connected to keyboard/mouse adapter 218, disk controller 220, and I/O adapter 222. Disk controller 220 can be connected to a storage 226, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 226 can store any data or code necessary for or usable in disclosed embodiments, and in particular can store executable code 252, which when executed cause one or more processors to perform processes as described herein, and data 254, which can include any of the data processed, generated, or stored as described herein.

Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, touchscreen, etc. I/O bus 216 can also be connected to other peripheral devices in various embodiments, such as (but not limited to) a printer, a optical scanner, an NFC, RFID, or other reader, a camera, or others.

Those of ordinary skill in the art will appreciate that the hardware depicted in FIG. 2 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure. In some embodiments, data processing system 100 can be implemented as one of multiple computers together implementing a system as described herein. In some embodiments, a data processing system 100 can be implemented, in whole or in part, with or as a part of a server computer, a desktop computer, a laptop computer, a portable electronic device or mobile device such as a tablet or mobile phone, or otherwise.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 212 can be connected to a network 230 (not a part of data processing system 200), which can be any public or private data processing system network or combination of networks, as known to those of skill in the art, including the Internet, and which can correspond to network 240. Data processing system 200 can communicate over network 230 with server system 240, which is also not part of data processing system 200, but can be implemented, for example, as a separate data processing system 200.

According to disclosed embodiments, a digital title includes a one-way encrypted certificate or code (the “title ID”) that is associated with the product. By using one-way encryption, the digital title and its title ID cannot be decrypted or reverse engineered to determine the original data encrypted into the digital title, though some of this data may be stored in unencrypted form as part of the digital title, for tracking the chain of title or other purposes. Other data can be included in the digital title with the title ID, such as unencrypted owner information, date information, or product information.

In specific examples, the title ID of a digital title can be generated from a combination of a validation seed, with or without other data. The other data can include, for example, product data such as a unique product identifier (ID) and an owner ID. The product ID can be any identifier capable of identifying the specific product, and in some embodiments, is implemented using a validation ID as described in the patent application incorporated by reference above. In various embodiments, the validation seed is a randomly or pseudo-randomly generated number. In various embodiments, the owner ID is any data that can be used to identify a specific owner, such as a telephone number, physical address or email address, social security number, employer identification number, driver license number, or other government-issued identifier, name, or other data, or any combination of these.

For example, to generate a title ID for a digital title, the system can concatenate or otherwise combine the product data (including the product ID), the validation seed, and the owner ID and use a hash function or cryptographic function on the combined product data, validation seed, and owner ID data to produce an encoded result that is used as the digital title or as part of the data of the digital title. The hash function, in this example, can be cyclic redundancy check algorithm, ad checksum algorithm, a universal hash function algorithm, a non-cryptographic hash function algorithm, a keyed cryptographic hash function algorithm, an unkeyed cryptographic hash function algorithm, or otherwise. The cryptographic function can be any cryptographic function that can use the combined validation seed and associated product data to produce the encoded result that is used as title ID.

As described herein, a title tracking system can maintains a chain of title for a product that includes one or more digital titles, each digital title having an encoded title ID and possible other information usable for tracking and organizing the digital title and chain of title. For example, a digital title may have the encoded title ID along with an unencrypted product data or product ID and unencrypted date information that describes the date on which the current ownership, represented by the encoded title ID, became effective.

The title tracking system can also store the validation seed for that product with the chain of title or a digital title for that product, which enables the title tracking system to re-encode the same product data (including the product ID), the validation seed, and an owner ID of an owner to be validated to determine if the generated title ID matches the stored title ID of the current digital title. If they title IDs match, then the owner to be validated is the correct current owner of the product. If the title IDs do not match, then the owner to be validated is not the current owner of the product according to the current digital title.

The chain of title itself may be stored by the title tracking system as a record that links the associated digital titles and other information, such as the product data (including the product ID), the validation seed, and the owner ID. In this way, the title tracking system can use any of this additional data to identify the correct chain of title and associated digital titles that correspond to, for example, a given product ID or owner ID. In this way, the title tracking system can identify all owners associated with a given product ID or all products associated with a given owner ID. The title tracking system keeps track of all digital titles of a product throughout its lifecycles. This product ownership history information can be used for product authentication and verification.

Disclosed embodiments provide a technological improvement to product ownership validation in that each owner/product combination has one unique ownership digital title. That digital title is associated with owner ID, which prevents the malicious sharing/selling of a certificate by a counterfeiting entity. Further, the title tracking system can maintains, track, and search ownership history information throughout a product's lifecycle. The history information over the life cycle of a product is stored in the digital titles in a chain of titles, and preferably cannot be modified by third parties, preventing any counterfeiting entity from tempering and cheating.

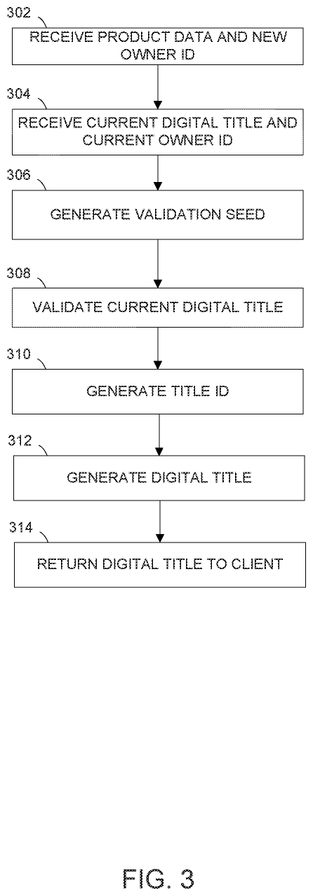

FIG. 3 illustrates a process in accordance with disclosed embodiments that be performed, for example, by title tracking system 102 as described herein or other system configured to perform processes as described, singularly or in combination with other systems, referred to generically as the “system” in this process. The process of FIG. 3 can be used to create and store a digital title and a chain of title for a product.

The system receives and stores product data and a new owner ID corresponding to a product (302). Product data preferably includes at least a product ID as described herein, and can include, for example, the brand name of the product, a manufacturer ID for the manufacturer of the product, the model name or number of the product, the universal product code (UPC) of the product, the serial number of the product, an expiration date of the product, a manufacture date of the product, a sales date of the product, a store ID or other information of the store that is selling the product or to which the product is being shipped, a retailer ID or other information of the retailer (e.g., a retail store chain) that is selling the product or to which the product is being shipped, or other information about a product. In some cases, the product data can include a URL or other address to verify the product at the validation system. Any one of these elements or any combination of these elements can be used as the product data in various embodiments. The “new” owner ID is the owner to whom the product should be registered with a digital title, or can represent the first owner of the product with a first digital title to the product, or can represent a new owner to whom a product with a current digital title is being transferred.

The system can receive the product data and new owner ID from any client system 104, which may be operated by, for example, the manufacturer or distributor of the product, the retailer of the product, a customer owner of the product, or otherwise, to generate a digital title for the product. The system can receive the product data and owner ID over the Internet or other network 130. In other cases, the client system and the title tracking system may be the same computer or set of computers so that “receiving” and “returning” refer to exchanging data between computer processes.

The system can also receive a current digital title and current owner ID for the product (304). In the case where title is being transferred from the current owner to a new owner, the current digital title can be verified before creating the new digital title as described herein.

The system generates and stores a validation seed associated with the product data and the new owner ID (306). The validation seed is any number, string, or other data used to uniquely produce the title ID from the product data and the new owner ID. The validation seed is associated with the product data and the new owner ID in that such an association between the generated validation seed and the product data/new owner ID is stored after the validation seed is generated. The association can be stored, for example, by linking the validation seed with the product data and the new owner ID in a data structure, or otherwise. The validation seed can be, for example, a randomly or pseudo-randomly generated number, and a new validation seed is preferably generated for each new title ID.

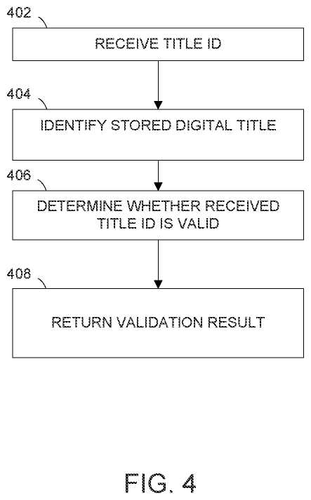

The system can validate the current digital title, for example by using a current title ID, alone or in combination with other data such as the full current digital title, the current owner ID, the product data, or others (308). This validation process can be performed as described herein, for example as described with regard to FIG. 4, and can be used to verify the transfer of title from the current owner to the new owner. If the validation fails, then the process of FIG. 3 can be aborted without creating a new digital title.

The system generates and stores a (new) title ID of a digital title using the validation seed, alone or in combination with other data as described herein, such as the product data, such as a unique product identifier, or the new owner ID (310). The generated title ID is associated with both the product and the product owner in the system. The association information is saved and can be used for product verification and history tracking.

For example, to generate the title ID, the system can concatenate or otherwise combine the validation seed and the associated product data and new owner ID and use a hash function or cryptographic function on the combined validation seed and associated product data to produce an encoded result that is used as the title ID. The hash function, in this example, can be cyclic redundancy check algorithm, ad checksum algorithm, a universal hash function algorithm, a non-cryptographic hash function algorithm, a keyed cryptographic hash function algorithm, an unkeyed cryptographic hash function algorithm, or otherwise. The cryptographic function can be any cryptographic function that can use the combined validation seed and associated product data to produce the encoded result that is used as the title ID.

In some cases, where the encoded result is a value or string that is longer than necessary or useful as a title ID, a portion of the encoded result can be used as the title ID. For example, if the encoded result is 256 characters, it may be sufficient to use only the first 64 or last 64 digits as the title ID.

In some cases, the validation seed can be “combined” with the associated product data and/or new owner ID by using the validation seed as the encryption seed or encryption code for the cryptographic function performed on the associated product data.

In any case, disclosed embodiments provide that producing the title ID is repeatable for a given validation seed and associated product data and owner ID, so that the same title ID is produced each time a given validation seed and, when appropriate, associated product data is used in 310.

The title ID is therefore an encoded identifier that is specific to that validation seed and the associated product data (preferably the unique product ID) and owner ID. Preferably, the validation seed is stored as associated with the digital title and not revealed to any third parties, so that the title ID can only be reproduced using that validation seed, its associated product data (preferably the unique product ID) and owner ID (when used to generate the original title ID), and the corresponding hash function or encryption function. Conversely, the title ID cannot be generated by third parties that do not know that validation seed, its associated product data (preferably the unique product ID) and owner ID, and the corresponding hash function or encryption function.

The system generates a digital title corresponding to the title ID (312). The digital title can be stored as associated with the digital title and any other data as described herein, such as the product data, new owner ID, the validation seed, or otherwise. In particular, the system stores the validation seed as associated with the digital title to ensure that the title ID is reproduceable using the same validation seed and other input data as described in 310. This process can include updating a chain of title for the product to indicate that the generated digital title is the current title for the product, including storing an effective date on which the generated digital title was generated.

The system can return the digital title, including the title ID, to the client system (or to another system) (314). The system can return the digital title over the Internet or other network 130. In some cases, the title ID can then be discarded by the system rather than stored persistently, since it can be regenerated on need using the same validation seed (and other data as used in generating the original title ID).

The generated digital title is typically returned to and kept by the new owner. This can be done, for example, by transmitting the digital title to the new owner via email, storing the digital title in the new owner's “digital wallet,” or otherwise. In other cases, “returning” the digital title can include transmitting the digital title to any system that is used to store such digital titles to prove ownership of the product.

FIG. 4 illustrates a process in accordance with disclosed embodiments that be performed, for example, by title tracking system 102 as described herein or other system configured to perform processes as described, singularly or in combination with other systems, referred to generically as the “system” in this process. The process of FIG. 4 can be used to validate current ownership of a product based on a digital title.

The system receives a title ID (alone or as part of a digital title) and/or one or more of product data and a current owner ID for a product from a client system (402). Product data preferably includes at least a product ID for the product as described herein, and can include, for example, the brand name of the product, a manufacturer ID for the manufacturer of the product, the model name or number of the product, the universal product code (UPC) of the product, the serial number of the product, an expiration date of the product, a manufacture date of the product, a sales date of the product, a store ID or other information of the store that is selling the product or to which the product is being shipped, a retailer ID or other information of the retailer (e.g., a retail store chain) that is selling the product or to which the product is being shipped, or other information about a product. In some cases, the product data can include a URL or other address to verify the product at the validation system. Any one of these elements or any combination of these elements can be used as the product data in various embodiments. The “current” owner ID corresponds to the person whose current ownership of the product is being validated. The system can receive this data, in some cases, by receiving a digital title to be validated (and so referred to herein as the “unvalidated digital title”). Preferably, the system receives a digital title that includes at least the title ID, the product ID, and the current owner ID. In this process, the received title ID can correspond to the digital title to be validated.

The system identifies a stored digital title corresponding to the received a title ID, product data, and/or current owner ID for a product (404).

The system determines whether the received title ID is valid by determining whether it matches the title ID associated with the stored digital title (406). As above, in some cases, the “previously-generated and stored validation ID” may be a validation ID that is regenerated from the validation seed (as described above, possibly including other data) and temporarily stored in order to make the determination.

The system determines whether the stored digital title is the current digital title for the product (408). This can include determining whether there is a more recent stored digital title for the product, with a different title ID, and can include analyzing a chain of title to determine whether the stored digital title is the current digital title.

The system returns a validation result to the client system based on the determinations of whether the received title ID is valid and whether the stored digital title is the current digital title (410).

In the case that the received title ID is invalid, because either the received title ID did not match the title ID associated with the stored digital title or because, even if the received title ID matched the title ID associated with the stored digital title, the stored digital title was not the current digital title, the validation result will be error message, “owner not validated” message, or similar message or code sent to the client system to indicate that the “current” owner is not the actual owner according to the chain of title records kept by the title tracking system. Any information other information described herein.

In the case that the received validation ID is valid in that the received title ID did matches the title ID associated with the stored digital title and the stored digital title is the current digital title, the validation result can be a simple “owner validated” message or similar message or code sent to the client system to indicate that the title ID (or its associated digital title) was valid. The validation result can include some or all of the product data associated with the previously-stored title ID and its digital tile, sent to the client system so that the user can confirm that the product data matches the product and owner being verified.

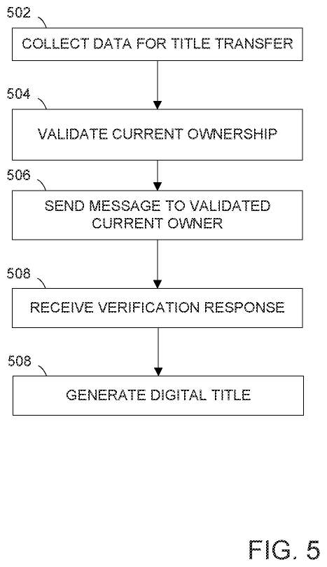

FIG. 5 illustrates a process in accordance with disclosed embodiments that be performed, for example, by title tracking system 102 as described herein or other system configured to perform processes as described, singularly or in combination with other systems, referred to generically as the “system” in this process. The process of FIG. 5 can be used to transfer current ownership of a product based on a digital title.

The system can collect data for a title transfer (502). This can include processes, for example as described in 302 and 304 above, which identify the current owner ID and the new owner ID for the product.

Based on the current digital title and current owner ID for the product, the system validates current ownership of the product (504). This can be performed using a process as described with respect to FIG. 4. If the current ownership is not validated, then this process can be aborted.

The system sends a message to the validated current owner to request verification of transfer of title to the new owner (506). This message can, for example, identify the product and the new owner. The message can be sent by email, text, web form, or any other known means of electronically sending a message to a user.

The system receives a verification response in response to the message (508). The verification response indicates whether the transfer of title to the new owner is approved by the current owner.

If the verification response indicates that the transfer of title is approved, then the system generates a new digital title, for example as described above with respect to FIG. 3 at 308-314 (510). A copy of the new digital title can be stored by the system and can be sent to the new owner, such as by email, deposit into the new owner's digital wallet, or otherwise.

If the verification response indicates that the transfer of title is not approved, then the system does not create a new digital title and the chain of title to the product remains with the current owner.

Of course, those of skill in the art will recognize that, unless specifically indicated or required by the sequence of operations, certain steps in the processes described above may be combined, omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method for product ownership validation, the method performed by a data processing system and comprising:
receiving, by the data processing system, product data and an owner identification (ID) corresponding to a product;
generating, by the data processing system, a validation seed associated with the product data;
generating, by the data processing system, a title ID using the validation seed, wherein the digital title is stored by the data processing system as associated with the validation seed and the owner ID;
generating, by the data processing system, a digital title corresponding to the title ID; and
returning, by the data processing system, the digital title.

2. The method of claim 1, wherein generating the title ID includes using a hash function or cryptographic function on the validation seed.

3. The method of claim 1, wherein generating the title ID includes using a hash function or cryptographic function on the validation seed combined with the associated product data.

4. The method of claim 1, wherein generating the title ID includes using a hash function or cryptographic function on the validation seed combined with the owner ID.

5. The method of claim 1, further comprising receiving, by the data processing system, an unvalidated digital title for the product, and validating, by the data processing system, the unvalidated digital title.

6. The method of claim 5, wherein validating the unvalidated digital title includes:
receiving, by the data processing system, a title ID corresponding to the unvalidated digital title;
identifying, by the data processing system, a stored digital title corresponding to the received title ID;
determining, by the data processing system, whether the received title ID matches a title ID associated with the stored digital title; and
returning, by the data processing system, a validation result according to the determination.

7. The method of claim 6, further comprising determining, by the data processing system, whether the stored digital title is a current digital title, and wherein the returning the validation result is according to both the determination of whether the received title ID matches the title ID associated with the stored digital title and the determination of whether the stored digital title is the current digital title.

8. The method of claim 7, wherein the received title ID is valid only when both the received title ID matches the title ID associated with the stored digital title and the stored digital title is the current digital title.

9. The method of claim 8, further comprising sending, by the data processing system, a message to a validated current owner of the product to verify transfer to title of the product to a new owner, the new owner corresponding to the received owner ID.

10. A data processing system, comprising:
a memory; and
at least one processor operatively connected to the memory, wherein the at least one processor is configured to:
receive product data and an owner identification (ID) corresponding to a product;
generate a validation seed associated with the product data;
generate a title ID using the validation seed and store the title ID as associated with the validation seed and the owner ID;
generate a digital title corresponding to the title ID; and
return the digital title.

11. The data processing system of claim 10, wherein generating the title ID includes using a hash function or cryptographic function on the validation seed.

12. The data processing system of claim 10, wherein generating the title ID includes using a hash function or cryptographic function on the validation seed combined with the associated product data.

13. The data processing system of claim 10, wherein generating the title ID includes using a hash function or cryptographic function on the validation seed combined with the owner ID.

14. The data processing system of claim 10, wherein the at least one processor is further configured to receive an unvalidated digital title for the product and validate the unvalidated digital title.

15. The data processing system of claim 14, wherein the at least one processor is further configured to:
receive a title ID corresponding to the unvalidated digital title;
identify a stored digital title corresponding to the received title ID;
determine whether the received title ID matches a title ID associated with the stored digital title; and
return a validation result according to the determination.

16. The data processing system of claim 15, wherein the at least one processor is further configured to determine whether the stored digital title is a current digital title, and wherein the returning the validation result is according to both the determination of whether the received title ID matches the title ID associated with the stored digital title and the determination of whether the stored digital title is the current digital title.

17. The data processing system of claim 16, wherein the received title ID is valid only when both the received title ID matches the title ID associated with the stored digital title and the stored digital title is the current digital title.

18. The data processing system of claim 10, wherein the at least one processor is further configured to send a message to a validated current owner of the product to verify transfer to title of the product to a new owner, the new owner corresponding to the received owner ID.

19. A machine-readable medium encoded with executable code that, when executed, cause one or more processors to:
receive product data and an owner identification (ID) corresponding to a product;
generate a validation seed associated with the product data;
generate a title ID using the validation seed and store the title ID as associated with the validation seed and the owner ID;
generate a digital title corresponding to the title ID; and
return the digital title.

20. The machine-readable medium of claim 19, further encoded with executable code that, when executed, cause the one or more processors to:
receive an unvalidated digital title for the product; and
validate the unvalidated digital title by:
receiving a title ID corresponding to the unvalidated digital title;
identifying a stored digital title corresponding to the received title ID;
determining whether the received title ID matches a title ID associated with the stored digital title; and
returning a validation result according to the determination.
